(19) United States
(12) Patent Application Publication
(10) Pub. No.: US 2024/0131647 A1
(43) Pub. Date: Apr. 25, 2024

(54) MACHINE TOOL CONTROLLER

(71) Applicant: FANUC CORPORATION, Yamanashi (JP)

(72) Inventor: Kouki OIKAWA, Yamanashi (JP)

(73) Assignee: FANUC CORPORATION, Yamanashi (JP)

(21) Appl. No.: 18/548,466

(22) PCT Filed: Mar. 13, 2022
(86) PCT No.: PCT/JP2022/011372

§ 371 Date: Aug. 29, 2023

(30) Foreign Application Priority Data
Mar. 17, 2021 (JP) 2021-044400

(51) Int. Cl. B23Q 15/12

(52) U.S. Cl. CPC B23Q 15/12

(57) ABSTRACT

Provided is a control device for a machine tool capable of stably achieving an effect of suppressing regenerative self-excited chatter vibration. This control device for a machine tool includes a fluctuation command calculation unit configured to calculate a fluctuation command based on a speed command for a main spindle motor of the machine tool and a fluctuation condition for causing a rotation speed of the main spindle motor to periodically fluctuate, and a speed control unit configured to control the rotation speed of the main spindle motor based on the speed command and the fluctuation command. The fluctuation command calculation unit is configured to calculate the fluctuation command by calculating a frequency of the rotation speed that periodically fluctuates of the main spindle motor based on the rotation speed of the main spindle motor based on the speed command and a frequency rate that is the fluctuation condition.

### TECHNICAL FIELD

The present disclosure relates to a control device for a machine tool.

### BACKGROUND ART

During cutting by a machine tool, chatter vibration may be continuously generated between a tool and a workpiece. Chatter vibration is classified into forced chatter vibration and self-excited chatter vibration according to the cause of vibration generation. Forced chatter vibration is generated under the influence of a forced vibration source, while self-excited chatter vibration is generated without a specific vibration source when both the dynamic characteristics of the machine tool and the cutting process satisfy a predetermined condition. Among self-excited chatter vibration, regenerative self-excited chatter vibration is caused by variations in chip thickness.

Conventionally, there has been known a technique of suppressing regenerative self-excited chatter vibration by causing the rotation speed of a main spindle of a machine tool to periodically fluctuate (for example, see Patent Document 1).

Patent Document 1: Japanese Unexamined Patent Application, Publication No. 2012-091283

### DISCLOSURE OF THE INVENTION

### Problems to be Solved by the Invention

However, the present Applicant has found that the higher the speed change rate of the rotation speed of the main spindle between the time point one rotation before and the current time point, the higher the effect of suppressing regenerative self-excited chatter vibration. That is, in the case where the conditions (amplitude and frequency) for causing the rotation speed of the main spindle to periodically fluctuate are given as absolute values as in the conventional art, the higher the rotation speed of the main spindle, the smaller the speed change rate, and thus stable suppression effect cannot be obtained. Therefore, there has been awaited a control device for a machine tool capable of stably achieving an effect of suppressing regenerative self-excited chatter vibration.

### Means for Solving the Problems

A control device for a machine tool according to the present disclosure includes a fluctuation command calculation unit configured to calculate a fluctuation command based on a speed command for a main spindle motor of the machine tool and a fluctuation condition for causing a rotation speed of the main spindle motor to periodically fluctuate, and a speed control unit configured to control the rotation speed of the main spindle motor based on the speed command and the fluctuation command. The fluctuation command calculation unit is configured to calculate the fluctuation command by calculating a frequency of the rotation speed that periodically fluctuates of the main spindle motor based on the rotation speed of the main spindle motor based on the speed command and a frequency rate that is the fluctuation condition.

### Effects of the Invention

According to the present disclosure, it is possible to stably obtain an effect of suppressing regenerative self-excited chatter vibration.

### BRIEF DESCRIPTION OF THE DRAWINGS

FIG. 1 shows an outline of a machine tool according to the present embodiment;

FIG. 2 is a flowchart showing a flow of processing of a motor control device according to the present embodiment;

FIG. 3 shows a time history of each of the rotation speed (main spindle speed), the main spindle rotation angle, and the speed change rate of a conventional main spindle motor, before changing the main spindle speed;

FIG. 4 shows a time history of each of the rotation speed (main spindle speed), the main spindle rotation angle, and the speed change rate of the conventional main spindle motor, after changing the main spindle speed;

FIG. 5 shows a time history of the rotation speed (main spindle speed) of the main spindle motor according to the present embodiment, in which the main spindle speed is 1200 [min⁻¹], and the fluctuation amplitude rate and the fluctuation frequency rate are both 10%;

FIG. 6 shows a time history of the rotation speed (main spindle speed) of the main spindle motor according to the present embodiment, in which the main spindle speed is 2400 [min⁻¹], and the fluctuation amplitude rate and the fluctuation frequency rate are both 10%;

FIG. 7 shows an example of a time history of each of the rotation speed (main spindle speed), the fluctuation amplitude, and the fluctuation frequency of the main spindle motor of the present embodiment;

FIG. 8 is a diagram for explaining the definition of the speed change rate, and shows a tool and a workpiece; and

FIG. 9 is a diagram for explaining the definition of the speed change rate, and shows a time history of each of the rotation speed (main spindle speed), the main spindle rotation angle, and the speed change rate of the main spindle motor.

### PREFERRED MODE FOR CARRYING OUT THE INVENTION

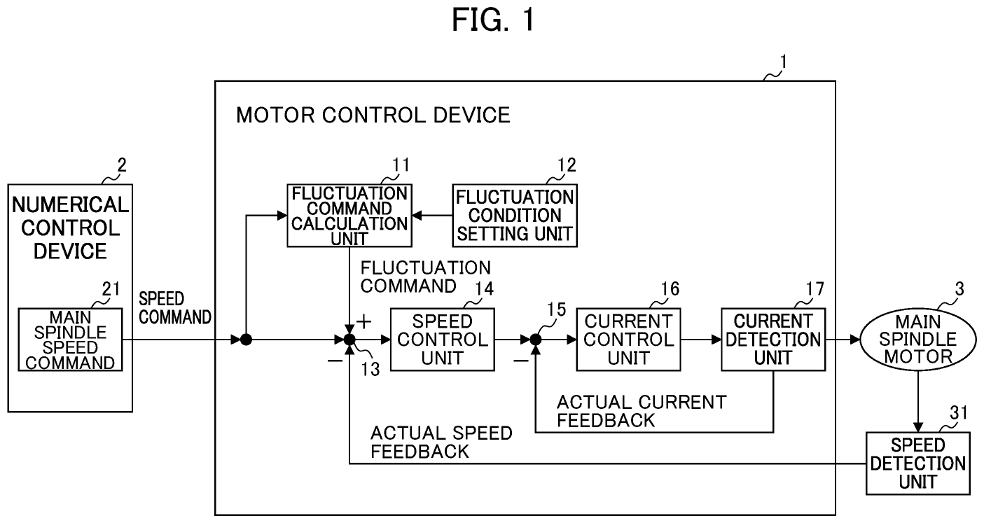

Hereinafter, an example of an embodiment of the present invention will be described. FIG. 1 shows an outline of a machine tool according to the present embodiment.

The machine tool controls a motor control device 1 based on a speed command from a numerical control device 2 and rotate a main spindle motor 3 to perform predetermined machining such as cutting. This machine tool suppresses regenerative self-excited chatter vibration by causing the rotation speed of the main spindle motor 3 to periodically fluctuate, for example, sinusoidally vibrate.

The motor control device 1 includes a fluctuation command calculation unit 11, a fluctuation condition setting unit 12, a speed control unit 14, a current control unit 16, and a current detection unit 17.

The fluctuation command calculation unit 11 calculates a fluctuation command based on a speed command for the main spindle motor 3 of the machine tool and fluctuation conditions for causing a rotation speed of the main spindle motor 3 to periodically fluctuate. Specifically, the fluctuation command calculation unit 11 calculates the amplitude of the periodically fluctuating rotation speed of the main spindle motor 3 by multiplying the rotation speed of the main spindle motor 3 based on the speed command by a fluctuation amplitude rate (hereinafter, simply referred to as an amplitude rate) that is a fluctuation condition. In addition, the fluctuation command calculation unit 11 calculates the frequency of the periodically fluctuating rotation speed of the main spindle motor 3 by multiplying the rotation speed of the main spindle motor 3 based on the speed command by a fluctuation frequency rate (hereinafter, simply referred to as a frequency rate) that is a fluctuation condition. Thereby, the fluctuation command calculation unit 11 calculates the fluctuation command.

More specifically, the fluctuation command calculation unit 11 calculates the amplitude A [min⁻¹] of the periodically fluctuating rotation speed of the main spindle motor 3 by multiplying the rotation speed S [min⁻¹] of the main spindle motor 3 based on the speed command by the amplitude rate a [%] that is the fluctuation condition. That is, the amplitude A [min⁻¹] is represented by A=S×(a/100). Furthermore, the fluctuation command calculation unit 11 calculates the frequency F [Hz] of the periodically fluctuating rotation speed of the main spindle motor 3 by multiplying a value by the frequency rate f [%] that is the fluctuation condition, the value being converted to a frequency [Hz] by dividing the rotation speed S [min⁻¹] of the main spindle motor 3 based on the speed command by 60. That is, the frequency F [Hz] is represented by F=(S/60)×(f/100).

The fluctuation condition setting unit 12 sets the amplitude rate a [%] and the frequency rate f [%] as the fluctuation conditions for causing the rotation speed of the main spindle motor 3 to periodically fluctuate, and outputs them as signals. For the setting of the fluctuation conditions, an input from a machining program, a parameter to be set, or the like are employed.

Reference numeral 13 denotes that a value is input as a signal to the speed control unit 14, the value being obtained by adding, to the speed command value output as a signal from a main spindle speed commander 21, the fluctuation command value output as a signal from the fluctuation command calculation unit 11, and subtracting, from the resulting value, the actual speed feedback value output as a signal from the speed detection unit 31.

The speed control unit 14 calculates a command for controlling the rotation speed of the main spindle motor 3 based on the speed command and the fluctuation command, and outputs the command as a signal.

Reference numeral 15 denotes that a value is input as a signal to the current control unit 16, the value being obtained by subtracting, from the command value output as a signal from the speed control unit 14, the actual current feedback value output as a signal from the current detection unit 17.

The current control unit 16 calculates a voltage command for driving the main spindle motor 3 based on the input signal, and outputs the voltage command as a signal.

The current detection unit 17 detects a signal that is a current value of the main spindle motor 3, and outputs a detection result as a signal of actual current feedback.

The numerical control device 2 includes the main spindle speed commander 21. The main spindle speed commander 21 calculates a speed command for the main spindle motor 3 and outputs it as a signal.

The main spindle motor 3 rotates under the control of the motor control device 1. The speed detection unit 31 detects the rotation speed of the main spindle motor 3 and outputs a detection result as a signal of actual speed feedback. As the speed detection unit 31, an encoder or the like is employed.

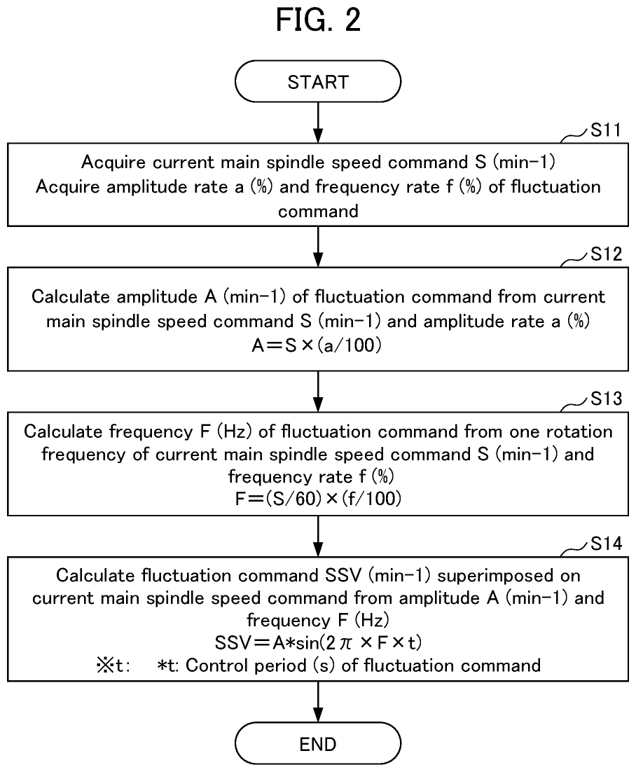

FIG. 2 is a flowchart showing the flow of processing of the motor control device 1 according to the present embodiment.

In Step S11, the fluctuation command calculation unit 11 acquires a speed command as a signal from the main spindle speed commander 21, and acquires an amplitude rate a [%] and a frequency rate f [%] that are fluctuation conditions as signals from the fluctuation condition setting unit 12.

In Step S12, the fluctuation command calculation unit 11 calculates the amplitude A [min⁻¹] of the periodically fluctuating rotation speed of the main spindle motor 3 by multiplying the rotation speed S [min⁻¹] of the main spindle motor 3 based on the speed command by the amplitude rate a [%] that is a fluctuation condition. The amplitude A [min⁻¹] is represented by A=S×(a/100).

In Step S13, the fluctuation command calculation unit 11 calculates the frequency F [Hz] of the periodically fluctuating rotation speed of the main spindle motor 3 by multiplying a value by the frequency rate f [%] that is a fluctuation condition, the value being converted to a frequency [Hz] by dividing the rotation speed S [min⁻¹] of the main spindle motor 3 based on the speed command by 60. The frequency F [Hz] is represented by F=(S/60)×(f/100).

In Step S14, the fluctuation command calculation unit 11 calculates a fluctuation command SSV [min⁻¹] from the amplitude A [min⁻¹] and the frequency F [Hz]. The fluctuation command SSV [min⁻¹] is represented by SSV=A×sin (2π×F×t).

Here, t [s] represents the control period of the fluctuation command.

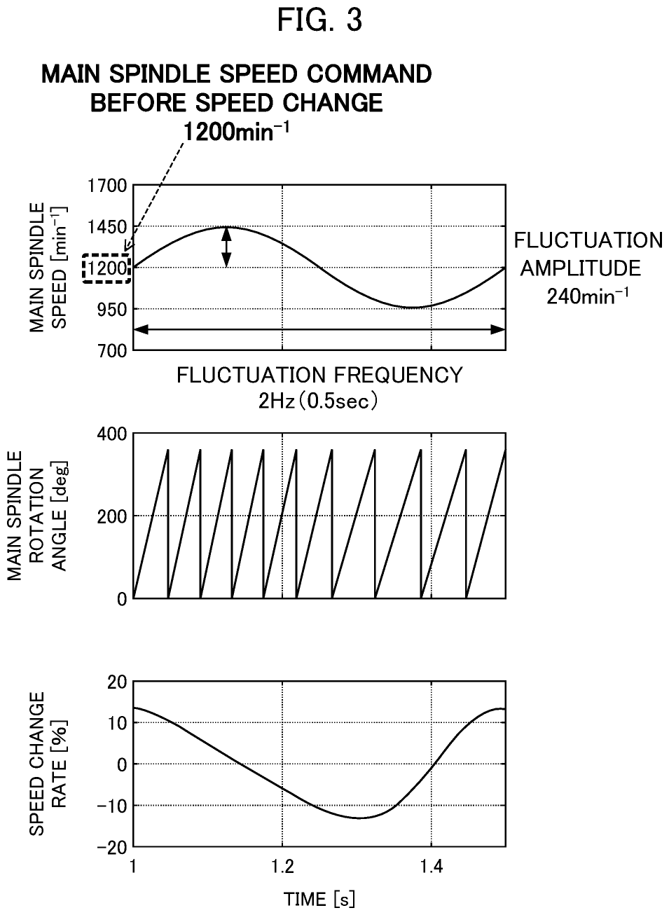

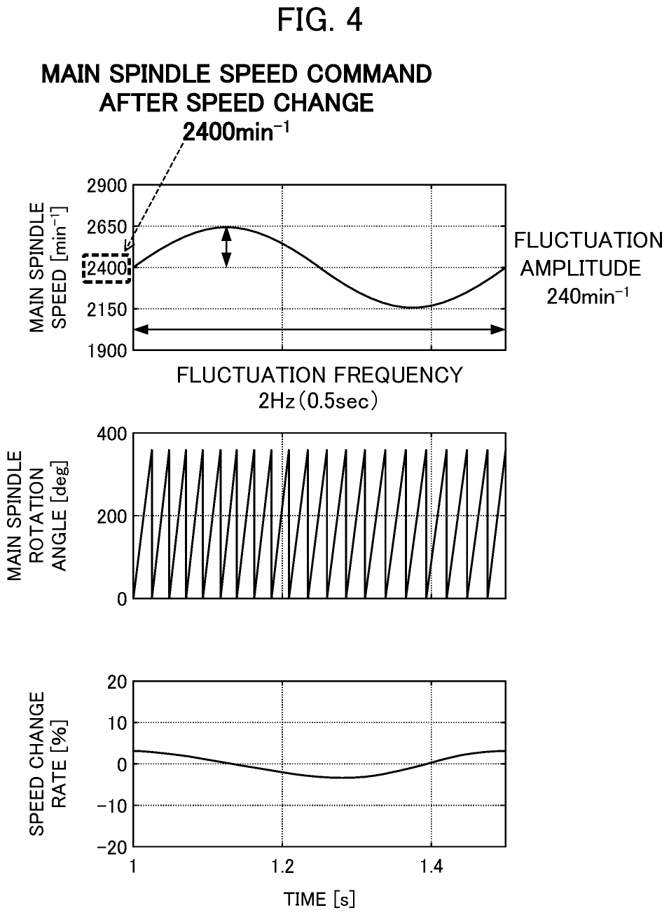

FIG. 3 shows a time history of each of the rotation speed (main spindle speed), the main spindle rotation angle, and the speed change rate of a conventional main spindle motor, before changing the main spindle speed. FIG. 4 shows a time history of each of the rotation speed (main spindle speed), the main spindle rotation angle, and the speed change rate of the conventional main spindle motor, after changing the main spindle speed.

The amplitude and frequency of the periodically fluctuating main spindle speed command for the conventional main spindle motor are determined by absolute values. For example, as shown in FIG. 3, when the main spindle speed is 1200±240 [min⁻¹], that is, when the amplitude is 240 [min⁻¹], the speed change rate changes from about −10% to 10%. In contrast, as shown in FIG. 4, when the main spindle speed is changed from 1200 [min⁻¹] to 2400 [min⁻¹] while the amplitude remains 240 [min⁻¹], the speed change rate changes from about −5% to 5%. Thus, in the conventional spindle motor, the speed change rate becomes small, and thus the effect of suppressing regenerative self-excited chatter vibration cannot be stably obtained.

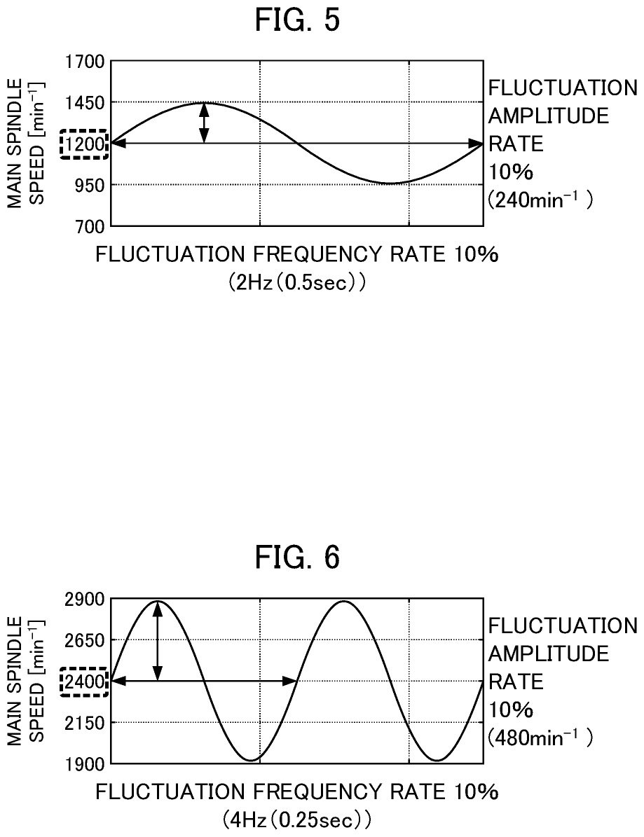

FIG. 5 shows a time history of the rotation speed (main spindle speed) of the main spindle motor according to the present embodiment, in which the main spindle speed is 1200 [min⁻¹], and the fluctuation amplitude rate and the fluctuation frequency rate are both 10%. FIG. 6 shows a time history of the rotation speed (main spindle speed) of the main spindle motor according to the present embodiment, in which the main spindle speed is 2400 [min⁻¹], and the fluctuation amplitude rate and the fluctuation frequency rate are both 10%.

As shown in FIGS. 5 and 6, in the present embodiment, the amplitude and the frequency of the periodically fluctuating main spindle speed command for the main spindle motor are each defined by a rate. Therefore, the fluctuation amplitude is 240 [min⁻¹] and the fluctuation frequency is 2 Hz (0.5 sec) in the example shown in FIG. 5, whereas the fluctuation amplitude is 480 [min⁻¹] and the fluctuation frequency is 4 Hz (0.25 sec) in the example shown in FIG. 6, which show that they differ from each other; however, the fluctuation amplitude rate and the fluctuation frequency rate are both 10% in both examples and identical to each other. Therefore, the speed change rate is kept constant regardless of the main spindle speed.

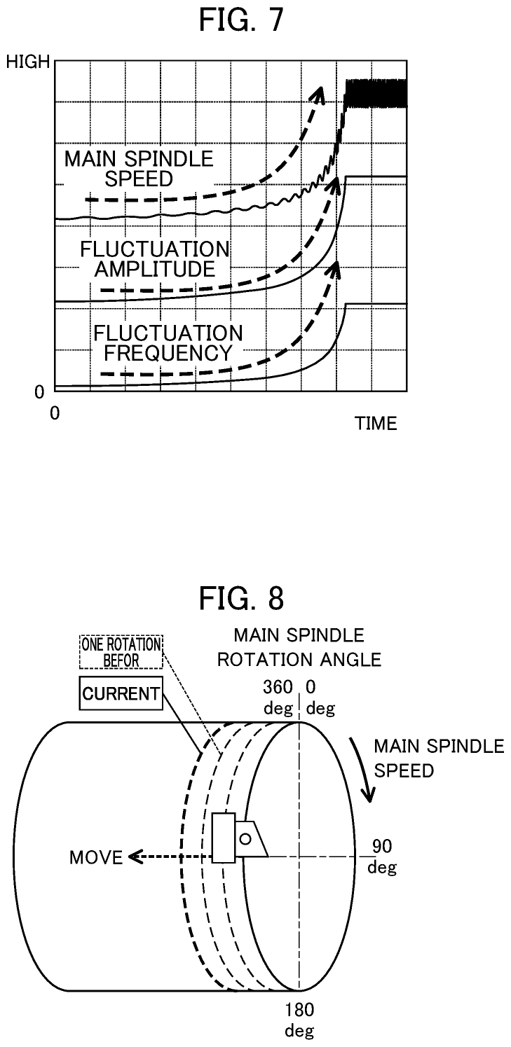

FIG. 7 shows an example of a time history of each of the rotation speed (main spindle speed), the fluctuation amplitude, and the fluctuation frequency of the main spindle motor of the present embodiment. As shown in FIG. 7, in the present embodiment, the fluctuation amplitude and the fluctuation frequency increase as the main spindle speed increases. That is, since the fluctuation amplitude rate and the fluctuation frequency rate are constant regardless of the main spindle speed, the speed change rate is kept constant. Therefore, it is possible to stably obtain an effect of suppressing regenerative self-excited chatter vibration.

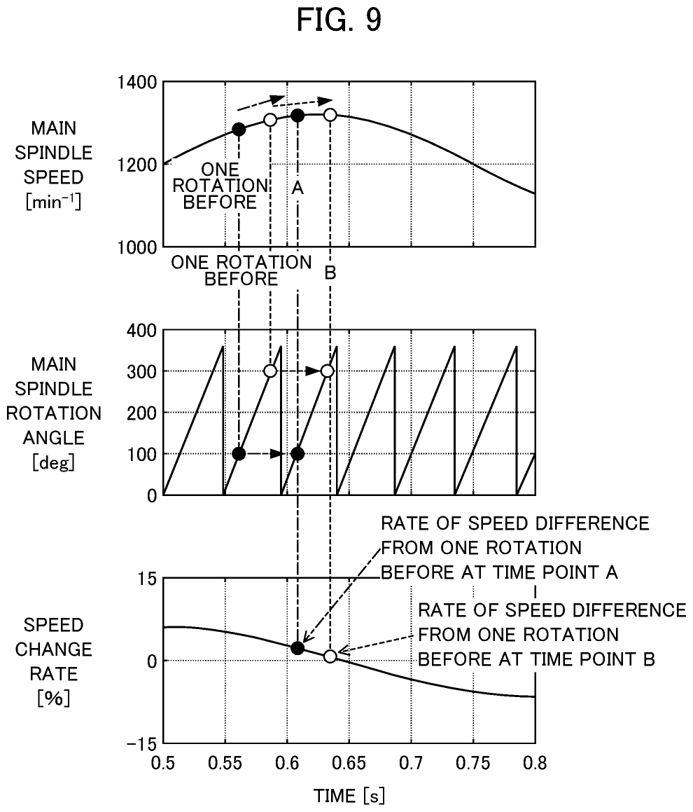

Here, the speed change rate will be described. FIG. 8 is a diagram for explaining the definition of the speed change rate, and shows a tool and a workpiece. FIG. 9 is a diagram for explaining the definition of the speed change rate, and shows a time history of each of the rotation speed (main spindle speed), the main spindle rotation angle, and the speed change rate of the main spindle motor 3.

As shown in FIG. 8, the direction of the rotation speed (main spindle speed) of the main spindle motor 3 is the direction in which the workpiece rotates, and is indicated by an arrow in FIG. 8. The main spindle rotation angle of the main spindle motor 3 is from 0 degrees to 360 degrees in one rotation. When the tool is moved in the axial direction, the outer peripheral surface of the cylindrical workpiece is cut by the tool.

As shown in FIG. 9, at time point A, the rotation speed (main spindle speed) of the main spindle motor 3 is 1315 [min⁻¹], and the main spindle rotation angle of the main spindle motor 3 is 100 degrees. At a time point one rotation before time point A, the main spindle speed is 1285 [min⁻¹], and the main spindle rotation angle is 100 degrees as at time point A. The speed change rate at time point A is obtained from the rate of the speed difference between the main spindle speed 1315 [min⁻¹] at time point A and the main spindle speed 1285 [min⁻¹] at the time point one rotation before time point A.

At time point B, the rotation speed (main spindle speed) of the main spindle motor 3 is 1315 [min⁻¹], and the main spindle rotation angle of the main spindle motor 3 is 300 degrees. At a time point one rotation before time point B, the main spindle speed is 1305 [min⁻¹], and the main spindle rotation angle is 300 degrees as at time point B. The speed change rate at time point B is obtained from the rate of the speed difference between the main spindle speed 1315 [min⁻¹] at time point B and the main spindle speed 1305 [min⁻¹] at the time point one rotation before time point B.

In the present embodiment, the main spindle speed command is caused to fluctuate such that the speed change rate defined as described above becomes constant. Specifically, the fluctuation amplitude and the fluctuation frequency are given at rates corresponding to the main spindle speed command. Thereby, the speed change rate is kept constant regardless of the main spindle speed command.

According to the present embodiment, the following effects are achieved.

The motor control device 1 according to the present embodiment includes the fluctuation command calculation unit 11 that calculates a fluctuation command based on a speed command for the main spindle motor 3 of the machine tool 1 and a fluctuation condition for causing a rotation speed of the main spindle motor 3 to periodically fluctuate, and the speed control unit 14 that controls the rotation speed of the main spindle motor 3 based on the speed command and the fluctuation command. The fluctuation command calculation unit 11 calculates the fluctuation command by calculating the frequency of the periodically fluctuating rotation speed of the main spindle motor 3 based on the rotation speed of the main spindle motor 3 based on the speed command and a frequency rate that is the fluctuation condition. As a result, in the case of machining programs with different main spindle speed commands or machining in which the main spindle speed command changes during machining, for example, during main spindle override, constant peripheral speed control, or the like, the speed change rate is kept constant, and therefore, it is possible to stably obtain an effect of suppressing regenerative self-excited chatter vibration.

In the motor control device 1 according to the present embodiment, the fluctuation command calculation unit 11 calculates the fluctuation command by calculating the amplitude of the periodically fluctuating rotation speed of the main spindle motor 3 based on the rotation speed of the main spindle motor 3 based on the speed command and the amplitude rate that is the fluctuation condition. This enables the above effect to be obtained more stably.

Embodiments of the present invention have been described above. The motor control device 1 can be implemented by hardware, software, or a combination thereof. Furthermore, the control methods performed by the motor control device 1 can also be implemented by hardware, software, or a combination thereof. It is to be noted that being implemented by software means being implemented by a computer reading and executing a program.

### EXPLANATION OF REFERENCE NUMERALS

1 motor control device
11 fluctuation command calculation unit
12 fluctuation condition setting unit
14 speed control unit
16 current control unit
17 current detection unit
2 numerical control device
21 main spindle speed commander
3 main spindle motor
31 speed detection unit

1. A control device for a machine tool, comprising:
a fluctuation command calculation unit configured to calculate a fluctuation command based on a speed command for a main spindle motor of the machine tool and a fluctuation condition for causing a rotation speed of the main spindle motor to periodically fluctuate; and
a speed control unit configured to control the rotation speed of the main spindle motor based on the speed command and the fluctuation command,
the fluctuation command calculation unit being configured to calculate the fluctuation command by calculating a frequency of the rotation speed that periodically fluctuates of the main spindle motor based on the rotation speed of the main spindle motor based on the speed command and a frequency rate that is the fluctuation condition.

2. The control device for the machine tool according to claim 1, wherein the fluctuation command calculation unit is configured to calculate the fluctuation command by calculating an amplitude of the rotation speed that periodically fluctuates of the main spindle motor based on the rotation speed of the main spindle motor based on the speed command and an amplitude rate that is the fluctuation condition.
